(19) United States
(12) Patent Application Publication
(10) Pub. No.: US 2007/0286013 A1
(43) Pub. Date: Dec. 13, 2007

(54) PORTABLE MIXING SHEET WITH HANDLES

(75) Inventor: Johnny B. Shoemaker, Austin, TX (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: SDS Design, Inc., Leander, TX (US)

(21) Appl. No.: 11/828,628

(22) Filed: Jul. 26, 2007

Related U.S. Application Data
(63) Continuation of application No. 11/382,801, filed on May 11, 2006, now abandoned.
Application No. 11/382,801 is a continuation of application No. 10/689,178, filed on Oct. 20, 2003, now abandoned.

(51) Int. Cl. B28C 5/18; B01F 13/00; B32B 19/00

(52) U.S. Cl. 366/53; 156/390; 366/130

(57) ABSTRACT

A flat portable mixing sheet with handles for manually blending materials in heterogeneous phases, particularly dry and liquid materials into a homogeneous mixture. The materials to be blended will be placed in the center of the mixing sheet and the handles of the sheet will be pulled alternately upward and toward the center of the sheet to tumble the materials while supported on the ground or floor into the required consistency. The mixed materials can then be transported on the sheet by the handles and poured into the designated location utilizing the midpoint along the side of the sheet as a spout. The handles are preferably made of high density polyethylene and thermally bonded to the mixing sheet.

### CROSS-REFERENCE TO RELATED APPLICATION

This application is a continuation of, and incorporates by reference in its entirety, Application No. 11/382,801, filed May 11, 2006 which claims priority from and incorporates by reference in its entirety prior Application No. 10/689,178, filed Oct. 20, 2003.

### BACKGROUND OF THE INVENTION

1. Field of the Invention

The field of the invention relates to a lightweight portable manual mixer for mixing two or more dry or liquid heterogeneous materials into a homogeneous mixture. This mixer is particularly applicable to the mixing very fine solids or small stones, e.g. pre-mix bagged concrete, with water. The mixer is very effective in a variety of applications, such as mixing dry small particle solids into a well-blended mixture, e.g. potting soil and sand, potpourri blends, large quantities of spices or random blending of small items.

### SUMMARY OF THE INVENTION

This invention provides a very simple method to easily mix/blend dry materials or dry and liquid materials together in a uniform consistency. This invention is particularly applicable to concrete mixing. Concrete herein will be used as a general term referring to mixtures of cement, sand, gravel, mortar, plaster, or the like to form building materials. Large quantities of concrete are mixed by powered machines, either by motored driven mixer at the work site or in a central batching and mixing plants, with the concrete delivered to the work site on a ready mix truck.

However; do-it-yourselfers, handymen, contractors and homeowners are mixing small batches of concrete on continuously increasing basis. For these small batches of concrete, building supply stores and lumberyards provide bagged pre-mixed concrete in 40/60/80-pound bags. A typical method to utilize the pre-mixed concrete for small jobs has been the use of a wheelbarrow or mortar box as the mixing container along with a hoe or shovel to mix in the required water.

Mixing sheets are known in the art. U.S. Pat. No. 5,743,636 (entitled Mixing Mat for Concrete) discloses a mixing sheet having a central reservoir. The prior art mixing sheets suffer from the disadvantage of not having a robust handle for gripping the sheet. Because the sheet can have nearly one-hundred pounds of materials, each side of which is being alternatively lifted and lowered, the ability to grip the edges for mixing is an important quality. The present invention is an improvement over the mixing sheet in U.S. Pat. No. 5,743,636 because the handles of the present invention are stronger than the integral handles of the prior art, and because the handles of the present invention permit more design flexibility in terms of location, size, shape, and number of handles. Further, the handles of the present invention can be made of a different material than that of the sheet, whereas the prior art handles cannot.

The present invention pertains to an improved mixing sheet having integral handles for grasping the sheet. The handles are bonded to the plastic sheet in such a manner as to be capable of supporting the loads the handle will have to bear.

The mixing sheet eliminates the need for a powered cement mixer, wheelbarrow, mixing box and hoe or shovel. With the mixing sheet the user can easily transport the concrete within the sheet to the pour location, then the mixing sheet transforms into a convenient spout the user can employ to pour the concrete into a small area in a very controlled manner. This greatly reduces waste and minimizes clean up of spilled concrete. After the project is completed the user can simply dispose of the sheet or rinse with water and store for future projects or use as a small protective cover.

### BRIEF DESCRIPTION OF THE DRAWINGS

In the following detailed description of exemplary embodiments of the invention, reference is made to the accompanying drawings, which form a part hereof, and in which is shown by way of illustration specific exemplary embodiments in which the invention may be practiced, and in which like numbers represent the same or similar elements and one or a plurality of such elements, as follows:

FIG. 1 is a plan view of a typical square flat mixing sheet with handles attached to each corner.

FIG. 2 is a plan view of a typical rectangular flat mixing sheet with handles attached to each corner.

FIG. 3 is a plan view of a typical circular flat mixing sheet with handles attached every 90 degrees around the perimeter of sheet.

FIG. 4-FIG. 19 are plan views of various applicable handle designs that can be adapted to meet specific sheet design requirements.

### DETAILED DESCRIPTION OF PREFERRED EMBODIMENTS

This invention provides a mixing sheet for producing a homogeneous mixture of two or more materials. The mixer is very effective in mixing dry small particle solids into a well-blended mixture, e.g. potting soil and sand, potpourri, large quantities of spices or random blending of small items. This mixer is particularly applicable to the mixing very fine solids or small stones, e.g. pre-mix bagged concrete, with water. For these small batches of concrete, building supply stores and lumberyards provide bagged pre-mixed concrete in 40/60/80-pound bags.

The invention utilizes a flat pliable sheet with handles bonded at four equidistant locations on the perimeter. The materials to be mixed are placed on the center of the sheet, next two individuals pull alternately upward and toward the center with the handles while the materials remain supported by the ground or floor. This action generates a lateral force between the mixing sheet and the material during the up and down sheet movement. The homogeneous mixture is quickly obtained with minimum effort. The mixing sheet is then utilized to transport the mixture to the designated location where pouring the contents is accomplished by lowering two opposing handles while raising the other two handles. The mid-point between the two lowered handles of the sheet becomes a convenient pouring spout for the mixture. This invention is an eloquent method to simply, cheaply, quickly and with minimum technical skill mix bagged premixed concrete, or two or more materials.

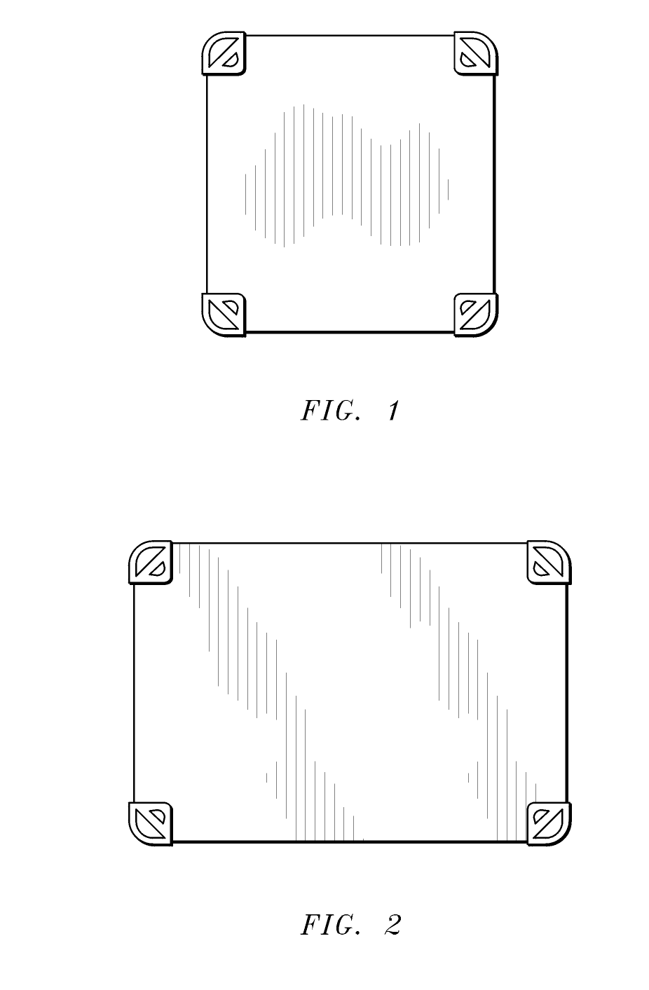

The concrete is mixed by placing the concrete mixture on the center of the mixing sheet and adding a premeasured amount of water or water in small amounts. Typical use of the sheet would require one person to grip two adjacent handles (FIG. 1 A/B) and another person to grip handles (FIG. 1 C/D). First, handle (FIG. 1 A) is pulled up and toward the center of the sheet; second, handle (FIG. 1 D) is pulled up and toward the center of the sheet; third, handle (FIG. 1 B) is pulled up and toward the center of the sheet and fourth, handle (FIG. 1 C) is pulled up and toward the center of the sheet. This action generates a lateral force between the mixing sheet and the material causing a tumbling action during the up and down sheet movement. This sequence is followed until the desired homogeneous consistency is obtained.

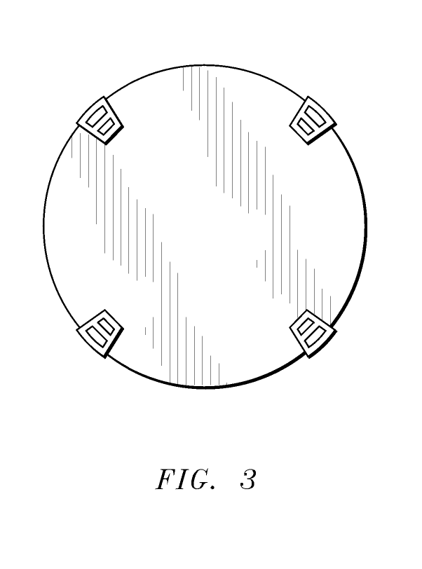

The mixing technique requires minimum effort because the mixture is tumbled while the sheet remains on the ground or floor and the user is only lifting a small amount of the mixture on any upward and toward the center of the sheet motion. The mixing sheet is then utilized to transport the mixture to the designated location where pouring the contents is accomplished by lowering two opposing handles (FIG. 1 A/C) while raising the other two handles (FIG. 1 B/D). The midpoint between of the sheet with the lower handles (FIG. 1 A/C) now becomes a convenient pouring spout. Lowering one set of handles (FIG. 1 A/C) while raising the other set of handles (FIG. 1 B/D) will increase the volume flow of the mixture; either raising handles (FIG. 1 A/C) or lowering the handles (FIG. 1 B/D) will decrease of the concrete. When mixing liquids the handles of mixing sheet should be raised to contain liquids until the mixing process takes place. The mixing procedure can also be accomplished by one individual by attaching two handles (FIG. 1 A/B) to a fixed elevated point and pulling alternately up and to the right with the left handle (FIG. 1 C) and up and left with the right handle (FIG. 1 D), or left on the remaining handles (FIG. 1 D/C). If materials move toward the back of the sheet the user can simply pull on the mid-point of the sheet between handles (FIG. 1 A/B) to relocate the material being mixed back to the center sheet. This mixing procedure for one individual also applies to the mixing sheets illustrated in FIG. 2 and FIG. 3.

In the preferred embodiment, the sheet material should be flexible, strong enough to hold the required weight, have water resistant properties and have material compatibility to accommodate attachment of handles, handles formed with the sheet or die cut handles. The sheet material should lend itself for mass production manufacturing capabilities and techniques. The material of choice for the mixing sheet is a low-density polyethylene (LDPE). The sheet can be strengthened if required by using a cord or doubling the sheet material around the perimeter of the sheet.

Most LDPE sheeting, also referred to as film, is produced by the process of extrusion. Polymer resin pellets are heated to melting point and the melted plastic is forced through a die to form a sheet. Stabilizers, plasticizers and fillers are added to the melted plastic to change the characteristics of the sheet to improve strength, flexibility and resilient features. Stabilizers protect the LDPE from the effects of ultraviolet light and the heat of forming. Plasticizers can be added to reduce brittleness and fillers can be used to increase stiffness. Extruders can produce LDPE in a wide range of colors. Colors can be added to custom blended to meet customer's requirements. The colors are added during the production of the sheet are uniformly distributed through the sheet.

LDPE sheeting can also be extruded in a wide assortment of surface textures. The texture is placed into the plastic during the production of the sheet. The texture can range into from very smooth to grain patterns that simulate natural textures. For this invention, the range of texture does not greatly effect the mixing sheet efficiency.

Coextrusion is the process of making multi-layered LDPE sheeting. A LDPE can be produced from multiple layers of similar polymers. Coextrusion can be used to add a special property of one polymer to the character of another polymer. A thin film of a more expensive ultraviolet-resistant LDPE can be coextruded over another material that is adversely affected by UV, producing a new material that has improved outdoor uses.

There can be many variations for sheeting that can meet requirements for this invention. The sheeting can be constructed for a heavy-duty application utilizing a vinyl laminated nylon reinforced tarp or vinyl coated tarp material. A medium duty application for the sheeting would utilize two sheets of high strength LDPE film laminated with a flexible reinforcement material placed between the two layers. A basic application would utilize LDPE sheeting ranging between 5-10 mils in thickness, although other thicknesses can be used within the scope of this invention.

In the preferred embodiment, handles for the mixing sheet should be light weight, strong enough to resist a pulling force consistent with the nature and weight of the material to be mixed, resistant to wear and weather, provide a comfortable grip and capable of providing a consistent compatible bond to the mixing sheet. The handles can be longitudinal halves and bonded on each side of the mixing sheet to provide a uniform load. Preferably, the sheeting material should be doubled in thickness by simply folding the matter over at the corners. Injected molded handles will have the capability to be attached to both sides of the mixing sheet. The handles when bonded to the mixing sheet should not form a concentrated stress point, which would cause the sheeting to tear away from the handle. The handles can be attached/bonded to the flat mixing sheet by thermal welding, mechanically, adhesives, forming, stitching or combinations of these techniques. Thermal bonding is the preferable approach, due to the low manufacturing cost and robust bond that can be achieved. Mechanical bonding with screws, rivets or friction and machine stitching techniques can be used, but are not preferred because they are more expensive to manufacture because they do not easily lend themselves for automated attachment of handles to LDPE sheeting.

With regard to the handle design, there is a wide range of possible handles within the scope of this invention. Each handle can have one or more grip locations. The grips can be smooth or with ripples to conform to fingers and any suitable cross section including elliptical, oval, rectangular, etc. The handles can be solid (hard) or flexible (soft). The handles can be formed from conventional materials such as wood, rope or metals along with manmade plastics or composite materials.

Handles are preferably manufactured from high-density polyethylene (HDPE) which is a rigid thermoplastic. HDPE has the advantageous properties of being lightweight, easily formed and mass produced, durable, inexpensive and has material compatibility with LDPE. The HDPE handles can be mass-produced by injected molding, will not burr like metal handles, corrosion proof, unaffected by common fuels or solvents and can perform when subjected to high and low ambient temperatures. A strong HDPE handle and LDPE sheet bond can be accomplished by thermal welding techniques such as infrared, laser, hot-plate, mechanical vibrations and spin welding. The thermal bond of the handle and the sheet allows for equal distribution of any loading on the handle. Thermal welding techniques allow for effective attachment of the handles to the mixing sheet required for mass production.

Wood handles have the tendency to absorb moisture, causing the handles to expand and contract due to changes in the environment. Wood handles have a weight disadvantage and are heavy when compared to the mixing sheet weight. Wood handles are more expensive and do not lend themselves to mass production. Attaching the wood handles to the mixing sheet would be limited to mechanical or adhesive bonding.

Metal handles have the advantage of mass production, required strength, durability and stable to environment changes. The preferably handles made from aluminum, magnesium, titanium and other lightweight metals are expensive to be utilized. Typical iron/steel metal handles have a disadvantage of added weight and attachment to the mixing sheet would require mechanical bonding.

Rope handles can be made with natural or synthetic materials and both are inexpensive. Natural fiber rope has similar disadvantages as the wood handles but is lightweight. Rope handles can not be easily mass-produced and will require either manual stitching or mechanical bonding to the mixing sheet. As a result, rope handles are a better choice than metal or wood handles, but are not as advantageous as HDPE.

Composite handles can be mass-produced and have required strength, durability, and stability to environmental changes. Composite handles do not have the material compatibility of HDPE and would require mechanical or adhesive bonding of the handles to the mixing sheet

A formed handle, which is an integral part of the mixing sheet, would preferably be produced simultaneously with the sheet production. The handle is the same composition as the mixing sheet and will be approximately 20-40 mils in thickness compared to a typical sheet thickness of 5-10 mils. Formed handles are the least expensive to manufacture, but are not as robust as HDPE handles. In some applications, they may be a reasonably compromise between durability and cost.

Soft handles are an integral part of the mixing sheet and are constructed by folding over the corner of the LDPE sheeting forming a double thickness. A simple LDPE patch can be adhered between or external of the folds for additional strength then a simple die cut forms the handle. The fold over die cut handle is an economically strong handle. Soft handles die cut into the mixing sheet could be more efficient than attaching handles to the mixing sheet initial expensive manufacturing requirements may be required.

In FIG. 1, the mixing sheet in a plan view is shown as a square shape. The square sheet has four equidistant handles on each corner. The handles FIG. 1 A/B/C/D allow the user easy grip to the mixing sheet to provide the necessary energy to mix materials. The square sheet allows the use of any two-adjacent handles because of their equidistant positions. The handles can be approximately 4-5 feet apart depending upon handle design. The square sheet also allows that the mixed materials can be poured from any side. The concrete is simply mixed by placing the concrete mixture on the center of the mixing sheet (FIG. 1) and adding a pre-measured amount of water or water in small amounts.

Typical use of the sheet would require one person to grip two adjacent handles (FIG. 1 A/B) and another person to grip handles (FIG. 1 C/D). First, handle (FIG. 1 A) is pulled up and toward the center of the sheet; second, handle (FIG. 1 D) is pulled up and toward the center of the sheet; third, handle (FIG. 1 B) is pulled up and toward the center of the sheet and fourth, handle (FIG. 1 C) is pulled up and toward the center of the sheet. This action generates a lateral force between the mixing sheet and the material causing a tumbling action during the up and down sheet movement. This sequence is followed until the desired homogeneous consistency is obtained. The mixing sheet is then utilized to transport the mixture to the designated location where pouring the contents is accomplished by lowering two opposing handles (FIG. 1 A/C) while raising the other two handles (FIG. 1 B/D). The mid-point between the two lowered handles (FIG. 1 A/C) of the sheet becomes a convenient pouring spout for the mixture. Lowering one set of handles (FIG. I A/C) while raising the other set of handles (FIG. 1 B/D) will increase the volume flow of the mixture; either raising handles (FIG. 1 A/C) or lowering the handles (FIG. 1 B/D) will decrease of the concrete. The symmetry of the square sheet has advantages in manufacturing due to limitations of extruders and ease of printing graphics on the sheet. The mixing procedure can also be accomplished by one individual by attaching two handles (FIG. 1 A/B) to a fixed elevated point and pulling alternately on the remaining handles (FIG. 1 D/C). The same one individual technique is applied to the mixing sheet illustrated in FIG. 2 and FIG. 3.

In FIG. 2, the rectangular sheet technique of use is the same as described for the square sheet. The rectangular sheet allows for more dimensional flexibility for distance between handles. This may be advantageous for allowing optimum handle location for varying arm lengths of individuals using the mixing sheet. The rectangular sheet would more applicable for pouring the materials between handles (FIG. 2 A/C) or handles (FIG. 2 C/D).

In FIG. 3, the circular sheet technique of use is the same as described for the square sheet. The major disadvantage for the round sheet is from additional manufacturing steps of cutting the circular form from a square or rectangular extruded sheet of LDPE resulting in material waste. The circular sheet has some small advantages when mixing liquids.

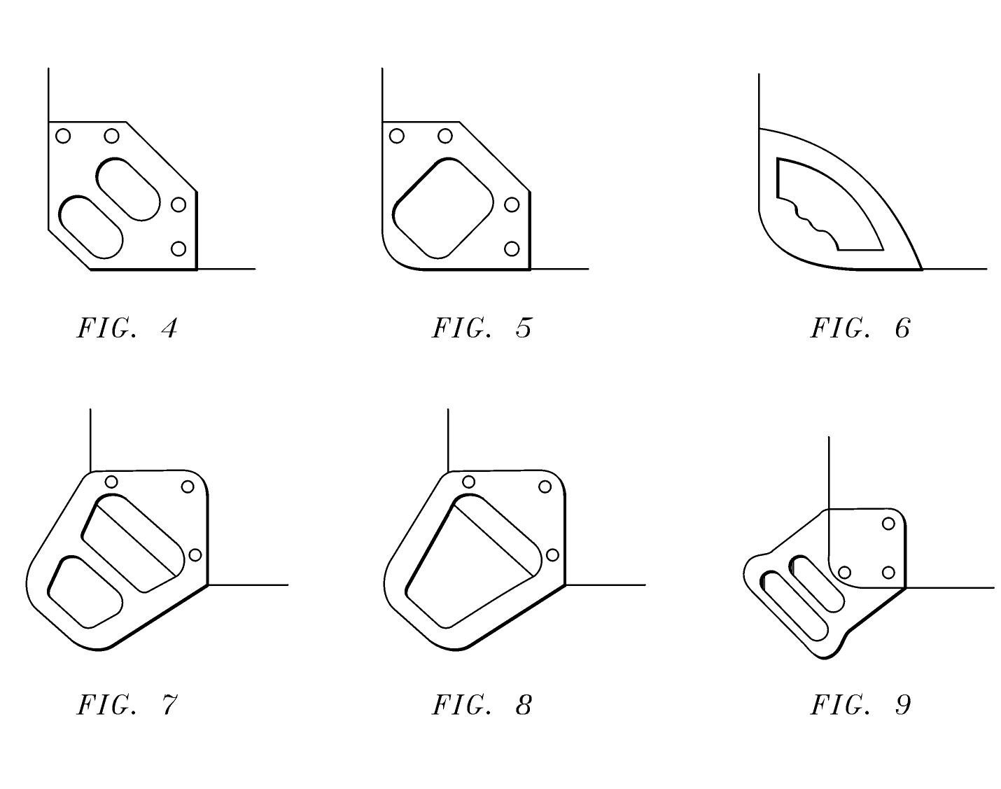

FIGS. 4 & 5 are illustrations for a handle bonded mechanically on the inside of the perimeter of the mixing sheet. This handle is longitudinally split to allow the sheeting to slide into the handle so mechanical pressure can be applied equally across the handle and sheeting. These handle designs provide maximum contact between and handle and sheeting. This handle location allows for a larger sheet use but minimizing the distance between the handles. In FIG. 4, the double handle hold allows for variation for individuals physical size and arm length.

FIG. 6 illustrates a formed handle, which is an integral part of the mixing sheet. The handle is the same composition as the mixing sheet and will be approximately 20-40 mils in thickness. This handle also shows a conforming finger grip.

FIGS. 7 & 8 are handles bonded mechanically on the perimeter of the mixing sheet. This handle is longitudinally split to allow the sheeting to slide into the handle so mechanical pressure can be applied equally across the handle where it is bonded the sheeting.

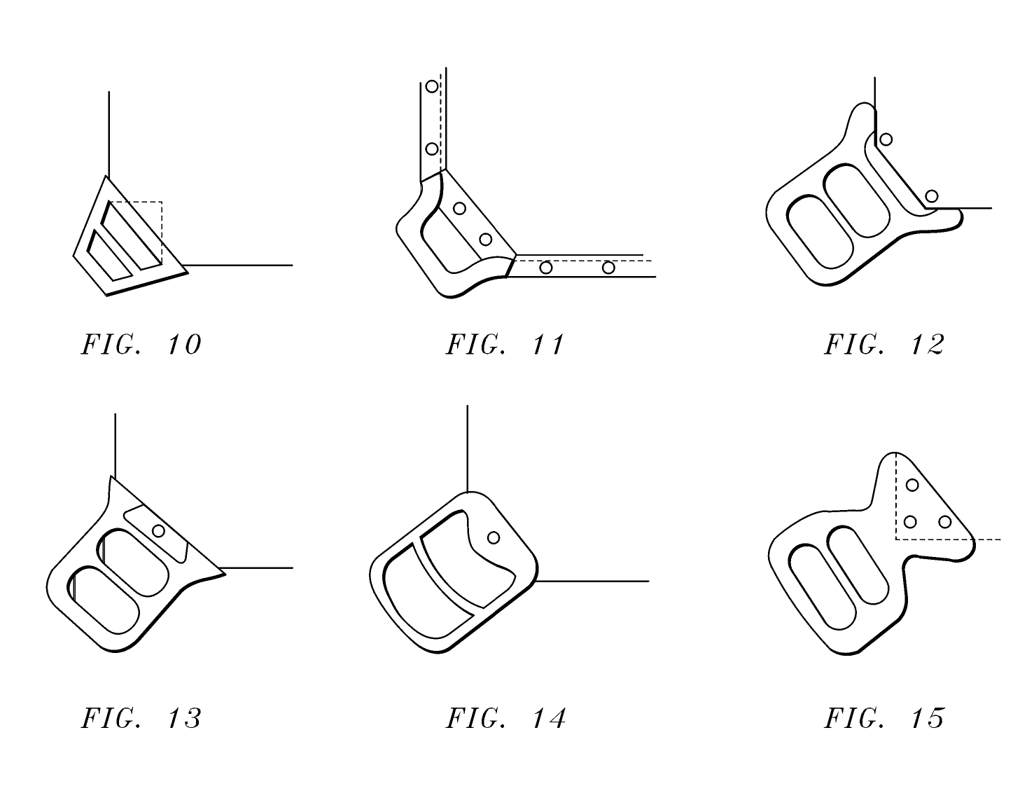

FIGS. 9, 12, 14 & 15 illustrates handles attached to the outer perimeter of the sheet, which allows for smaller sheet dimensions but providing greater distance between the handle holds. These handles also illustrate different attachment patterns to the sheet and mechanical securing locations. Again the double hand hold positions on the handles allow for varying individual physical size and arm lengths.

FIG. 11 depicts a flexible rope handle which can be attached mechanically or by sewing to the perimeter sheet material at each handle location. This handle design can provide for a continuous rope to extend around the total perimeter of the sheet, which provides added tensile strength to the edge of the sheet.

FIGS. 10 & 13 illustrate a mechanical wedge attachment. The handle is attached by mechanically holding the sheet material between the handle and a wedge; the wedge is pressed into the handle providing the required bonding. The stress on the sheet material can be equally distributed along the length of the wedge reducing any potential point loading.

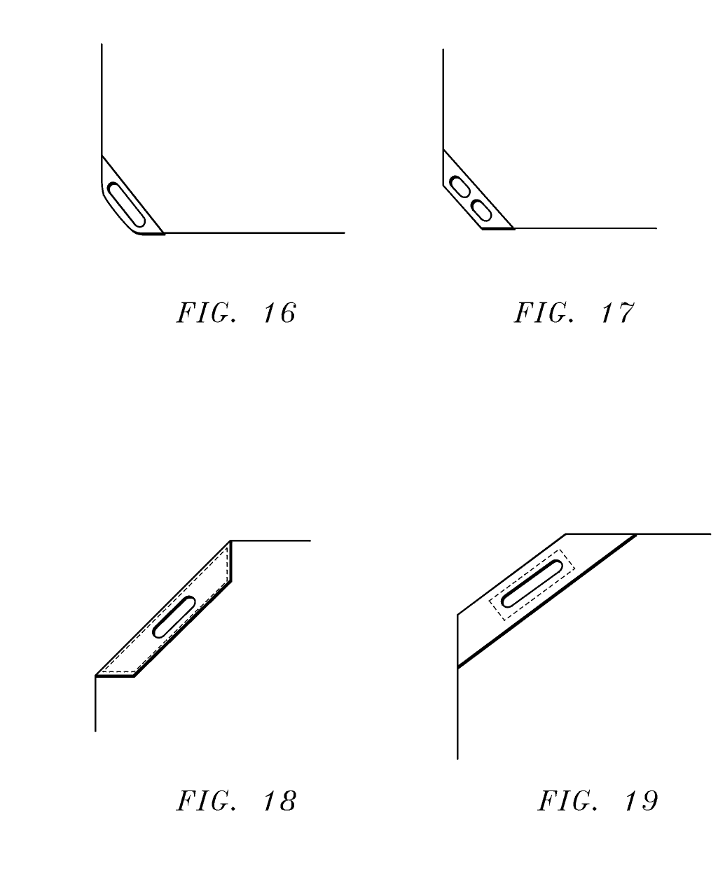

FIGS. 16 & 17 are HDPE handles that are thermally welded to a LDPE sheeting material. These handles provide for a long contact length between the handle and the sheeting, which provides good stress distribution of the sheeting. This handle can be injected molded with a slot along the edge of handle to allow the plastic sheet to be folded and inserted for thermal welding. The handle in FIG. 17 has a rib mid-point of the handle opening to provide additional strength.

FIG. 18 is a handle, which formed by folding the corner of the sheet and stitching around the perimeter of the fold and cutting out the grip location. Reinforcing the perimeter of the handle with a cord can strengthen this handle.

FIG. 19 Soft handles are an integral part of the mixing sheet and are constructed by folding over the corner of the LDPE sheeting forming a double thickness which is thermally welded together. A simple LDPE patch can be adhered for additional strength then a simple die cut forms the handle.

1. A mixing sheet comprising:
a flat pliable sheet,
at least one handle attached to the outer perimeter of said sheet, wherein a portion of said handle is attached to one side of said sheet and another portion of said handle is attached to the other side of said sheet and said handle is embossed to said sheet without any adhesive overlay.

2. The mixing sheet of claim 1 wherein the portion of said sheet to which the handle is secured is doubled in thickness by folding said sheet over onto itself in the location of said handle.

3. The mixing sheet of claim 1 wherein said handles are manufactured from materials selected from the group consisting of high-density polyethylene, wood, rope and composite.

4. The mixing sheet of claim 1 wherein said handle is attached to said sheet by a process selected from the group consisting of thermal welding, mechanical attachment, ultrasonic welding, adhesive attachment of stitching.

5. The mixing sheet of claim 1 wherein said sheet is between 5 and 10 mils thick.

6. A mixing sheet comprising:
a flat pliable sheet,
attaching at least one handle to a flat pliable sheet, a portion of said handle being attached to one side of said sheet and another portion of said handle being attached to the other side of said sheet and said handle is embossed to said sheet without any adhesive overlay.

7. A method for manufacturing a mixing sheet comprising:
attaching at least one handle to a flat pliable sheet, a portion of said handle being attached to one side of said sheet and another portion of said handle being attached to the other side of said sheet and said handle is embossed to said sheet without any adhesive overlay.

8. A method for mixing materials comprising:
attaching at least one handle to a flat pliable sheet, a portion of said handle being attached to one side of said sheet and another portion of said handle being attached to the other side of said sheet;
applying a combination of materials on top of said sheet; and
manipulating said at least one handle to mix said concrete.
